(19) United States
(12) Patent Application Publication
(10) Pub. No.: US 2013/0325495 A1
(43) Pub. Date: Dec. 5, 2013

(54) ENHANCED AUTOMATIC DATA COLLECTION AND PROCESSING FOR TRACKING HEALTHCARE ACTIVITIES

(71) Applicant: TetriDyn Solutions, Inc., Idaho Falls, ID (US)

(72) Inventors: David W. Hempstead, Idaho Falls, ID (US); Antoinette R. Knapp, Idaho Falls, ID (US); Amos D. Young, Chubbuck, ID (US); Orville J. Hendrickson, Idaho Falls, ID (US); Larry J. Ybarrondo, Las Vegas, NV (US)

(21) Appl. No.: 13/907,517

(22) Filed: May 31, 2013

Related U.S. Application Data
(60) Provisional application No. 61/653,452, filed on May 31, 2012.

(51) Int. Cl. G06Q 10/06; G06Q 50/22

(52) U.S. Cl. CPC G06Q 10/063114; G06Q 50/22
USPC 705/2

(57) ABSTRACT

An example embodiment includes a method of employee activity and performance tracking. The method includes receiving data packets from a base station. The data packets include locational information pertaining to one or more employees. The method also includes calculating an event timeframe from the data packets. The event timeframe includes a start date/time of an event, an end date/time of the event, a location of the event, and an identification of one or more employees involved in the event. The method further includes refining the event timeframe and communicating the event timeframe to the one or more employees identified in the event timeframe. The method also includes receiving a designation by the one or more employees, the designation including details of the event. The method further includes storing the data packets, the event timeframe, and the designation.

### CROSS-REFERENCE TO RELATED APPLICATIONS

This application claims priority to, and the benefit of, U.S. Provisional Patent Application Ser. No. 61/653,452 filed on May 31, 2012, which is incorporated by reference herein in its entirety.

### FIELD

Some embodiments discussed herein are related to data collection and data processing for tracking healthcare activity provided by a facility. The data is used to improve resident care and provide the facility with tools to optimize operations and processes within the facility.

### BACKGROUND

Facilities such as hospitals, nursing homes, assisted living facilities, long-term care facilities, personal residences in which home healthcare is needed, and all other domestic or international healthcare facilities (collectively, facility or facilities) provide care to residents. The facilities engage a variety of individuals including, but not limited to, certified nursing assistants (CNAs), registered nurses (RNs), therapists, vendors, maintenance personnel, and others. The term “employee” or “employees” is used herein to refer to any of these individuals. The employees may be directly employed by a facility or may be contracted from a third party to provide services for or in the facility. To bill for the care provided to the residents, an employee who provides the care may have to document the type of care provided and the resident to which the care was provided. Over the course of a shift or a day, the employee may see multiple residents and provide multiple types of care. Accordingly, the employee may forget or otherwise fail to accurately document each event in which care was provided. The delay in documentation may negatively affect the accuracy of the documentation. By avoiding delayed documentation, a facility can decrease instances of an incorrect type of care provided to a resident, a type of care rendered to an incorrect resident, an entirely forgotten instance of care, etc.

Alternatively, the employee may stop following each instance of care to document the care provided. For example, in some facilities, a documentation application may be included in a mobile device or another device. The employee may be able to enter details of the care provided directly into a mobile device immediately following providing care to a resident. However, the employee may have to carry the mobile device with him. Additionally, the documentation process stops the employee between each instance of care, interrupting the employee and reducing efficiency of the employee.

Additionally, the timeliness, completeness, and accuracy of documentation falls on the employee's ability and/or willingness to accurately document each instance of care or each resident encounter. The employee may become less willing to accurately document the care provided as the employee becomes busier or as a shift progresses.

Accurate documentation by employees is particularly important in facilities that provide care with the intent of being reimbursed by healthcare payers that include, but are not limited to insurance companies, the Medicare and/or Medicaid Systems, direct pay authorities, health exchanges, and/or other entities that pay for or provide reimbursement for services rendered. Healthcare payers often require documentation be formatted in a specific manner. For example, guidelines regulated by Centers for Medicare & Medicaid Services (CMS) require specific documentation of each instance of care provided by each employee. In the CMS guidelines the instances of care may be referred to as points of care (POC), a subset of which are referred to as activities of daily living (ADL). When the ADL and the POC are properly documented, then the facility may be reimbursed by the Medicare and/or Medicaid systems or another healthcare payer. If the POC and/or ADL are not properly documented, the facility is not reimbursed or may be flagged as fraudulently reporting the care provided.

The subject matter claimed herein is not limited to embodiments that solve any disadvantages or that operate only in environments such as those described herein. Rather, this background is only provided to illustrate one example technology area where some embodiments described herein may be practiced.

### SUMMARY

Example embodiments include systems and methods for employee activity and performance tracking. For example, an activity tracking system used to track data, such as locational information pertaining to one or more employees in a facility, is disclosed. The data may be captured through use of tags affixed or attached to employees, residents, locations in the facility, assets, or any combination thereof. The tags may include active and/or passive radio frequency identification (RFID) tags or other wireless/remote input medium such as infrared (IR) or spread spectrum tags that are configured to communicate with each other and a central station. In some contemplated implementations, the system may include a first RFID tag (for example, associated with an employee), a second RFID tag (for example, associated with a resident), and a third RFID (for example, associated with a location). The second tag is then configured to generate “data packets” when the first tag is within a predefined proximity of the second tag. The data packets indicate the location that the encounter occurred.

In some example systems, a base station is configured to receive the data packets from the second tag, and the central station is configured to receive the data packets from the base station. In some contemplated embodiments, the central station includes a programmable processor (essentially any appropriate computing device) that is programmed to calculate an event timeframe from the data packets. The event timeframe might include, for example, a start date/time of an event, an end date/time of the event, a location of the event, an identification of one or more employees involved in the event, and an identification of one or more residents involved in the event.

In example embodiments, a database can be maintained, for example at the central station, thereby allowing for the compilation, storage and manipulation of different data types relevant to any one of a number of applications. For example, methods might include further refining the event timeframe and communicating the event timeframe to the employee identified in the event timeframe. The employee may then designate, for example, the type of care provided to the patient/resident during the presented event timeframe. The designation by the employee can include any relevant details of the corresponding event, thereby providing the ability to accurately capture (and store in the database for further manipulation and analysis) appropriate documentation associated with events. The method further includes storing the data packets, the event timeframe, and the designation in the database. Of course other information might be provided as needed for a particular application. For example, for selected critical events, a computer or phone notification may be sent to designated, responsible management supervision or other personnel who may be involved in providing an appropriate response.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an activity tracking system (system) in which some embodiments discussed herein may be included;

FIG. 2 illustrates the system of FIG. 1 with an alternative configuration of tags;

FIG. 3 illustrates an example system configuration of the system of FIG. 1 interfacing with external systems;

FIG. 4 illustrates a flow diagram of an example method for employee activity and performance tracking that can be implemented in the system of FIG. 1; and

FIG. 5 is a block diagram illustrating an example computing device that is arranged for tracking employee activity and performance, in accordance with at least some embodiments described herein.

### DESCRIPTION OF SOME EXAMPLE EMBODIMENTS

Some embodiments discussed herein are related to tracking employee activities and performance to document and bill points of care (POC) events and activities of daily living (ADL) events. An example embodiment includes a system used to track data including locational information pertaining to one or more employees in a facility. The locational information may be used to capture POC and/or ADL provided to one or more residents in the facility. The POC and/or ADL include billable services for which the facility may receive payment based on guidelines regulated by a healthcare payer. The term “healthcare payer” is used herein to refer to entities that pay or reimburse facilities for provided services such as Centers for Medicare & Medicaid Services (CMS), direct pay authorities, insurance providers, health exchanges, and/or other entities that pay for or provide reimbursement for services rendered. The guidelines of the CMS are herein referred to as CMS guidelines.

The system may be configured to capture data indicating a period of time spent by the employee in a location associated with a resident or a period of time spent near a resident. The data may be captured through use of active and/or passive radio frequency identification (RFID) tags configured to communicate with each other. The RFID tags may be positioned throughout the facility, secured to employees, secured to residents, secured to visitors or individuals with temporarily access to the facility, secured to assets of the facility such as wheelchairs, walkers, medical equipment, etc. The RFID tags determine the locational information pertaining to when specific individuals (e.g., the employee, the resident, and visitors) are positioned in specific locations. The locational information may then be communicated to a base station and subsequently to a central station. The central station may process the data into event timeframes and store the locational information and/or the data in a database.

The system may then present event timeframes along with the location and/or the resident to an employee. The employee may then designate the type of care provided to the resident during the presented event timeframe. By having the event timeframe determined electronically, the system creates a level of accountability and objective documentation that an event occurred in which care has been provided.

When the employee designates the type of care provided to the resident, documentation including the event timeframe, the event, type of care provided during the event, the resident, etc. may be collected. The system may then generate a resident score and/or tabulate the documentation based on the CMS guidelines or another healthcare payer's preference.

In this example embodiment, the system provides the ability to accurately and efficiently capture documentation of care provided for POC. In addition to providing valuable documentation about patient care, this system may also provide required background data for payment for the provided care. Additionally, by introducing RFID tags, the burden on the employee of remembering and documenting the provided care may be reduced when compared to systems without the RFID tags. The employee's responsibility is simply to document via a computerized interface what care, if any, was provided during the presented event timeframe. Additionally, the system improves employee accountability because the system records and presents the event timeframes to the employee. In some facilities, the employee is required to respond with some level of documentation to the event timeframes presented. Accordingly, a higher portion of resident encounters may be accurately documented.

Reference will now be made to the figures wherein like structures will be provided with like reference designations. It is understood that the figures are diagrammatic and schematic representations of some embodiments and are not limiting of the present invention, nor are they necessarily drawn to scale.

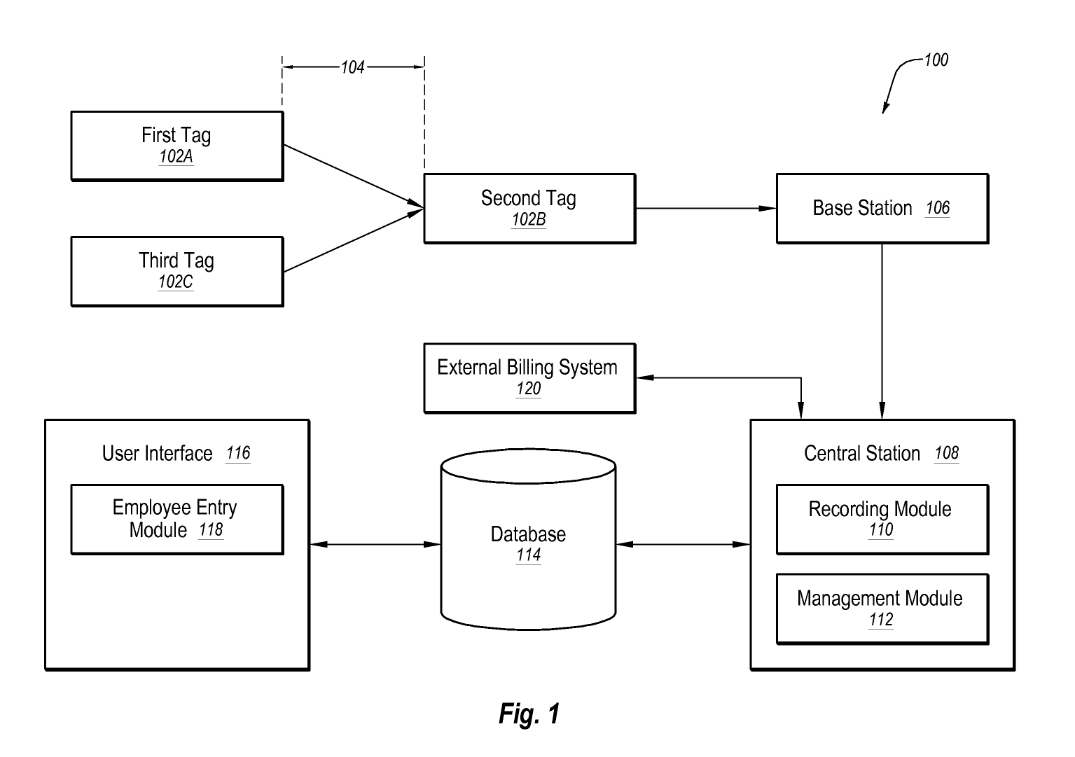

FIG. 1 illustrates an activity and performance tracking system (system) 100 in which some embodiments discussed herein may be included. The system 100 may be generally included in a facility. The facility as discussed in detail herein may generally include a healthcare facility such as an assisted living facility, a hospital, a nursing home, a long-term care facility. The embodiments described herein relate to activities and performance indicators relevant to a healthcare facility. However, it will be appreciated with the benefit of this disclosure that the system 100 may be utilized in any facility or environment that may benefit by recording and/or or tracking activities of individuals. For example, other facilities may include military training facilities, prisons, mental institutions, airports, department stores, public assembly facilities such as stadiums or public buildings, and large vehicles such as cruise ships, oil tankers, or naval vessels. Additionally, the system 100 may be used in environments in which tracking individuals' locations may be beneficial such as battlefields, sport-training environments or emergency response environments.

Through tracking activities of individuals, the system 100 may provide accountability and accordingly generate documentation related to the activities of the individuals within the facility. The individuals may include residents, employees, individuals with temporary access to the facility, or some combination thereof. The term “residents” as used herein refers to patients or persons cared for in the facility. The employees may include certified nursing assistants (CNAs), registered nurses (RNs), therapists, vendors, maintenance personnel, supervisory personnel, etc. who work in the facility or otherwise provide care to the residents. The individuals with temporary access to the facility may include visitors, equipment maintenance or installation personnel, delivery people, etc.

The system 100 generally enables automatic collection and processing of data used to track healthcare activity and improve resident care. Additionally, the data may provide the facility or facility management with tools to optimize operations and processes within the facility. For example, the data may be used to track employee activities and performance to document and bill POC events and ADL events. The data may also provide location identification for employees, residents, visitors such as family/friends, medical personnel, vendors, maintenance personnel, an asset, or any combination thereof. The data may also provide a mechanism to prevent resident elopements, falls, or injury and/or provide notifications to employees to facilitate immediate response to calls for help and/or falls. The data may also provide informative care information to residents' family; streamline and provide a secure and thorough facility audit processes; and the data may be processed into meaningful and objective information for facility management regarding care provided to the facility's residents and/or performance of facility employees, including prevention and/or deterrence of time card fraud.

The system 100 may include two or more tags 102A-102C (generally, tag 102 or tags 102). The tags 102 may be configured to generate data packets based on the presence of a tag 102 within a predetermined proximity 104 of another tag 102. For example, a second tag 102B may be configured to generate data packets when a first tag 102A is within a predefined proximity 104 of the second tag 102B. Additionally or alternatively, the second tag 102B may be configured to generate two data packets when the first tag 102A and a third tag 102C are within the predefined proximity 104 of the second tag 102B. The tags 102 may then communicate the data packets to a base station 106 (described herein).

The tags 102 may be uniquely associated with a location or an individual, such as an employee or a resident. Accordingly, when the first tag 102A and/or the third tag 102C are within the predefined proximity 104 of the second tag 102B, the data packet generated by the second tag 102B may include information pertaining to the identity of the individual associated with one or more of the tags 102 and the location associated with one of the tags 102.

Additionally, a time period during which the first tag 102A and/or the third tag 102C are within the predefined proximity 104 of the second tag 102B may be calculated. The time period during which the tags 102 are within the predetermined proximity 104 may be determined by time stamping each of the data packet indicating that the first tag 102A and/or the third tag 102C are within the predefined proximity 104 of the second tag 102B. In some embodiments, the data packets are generated during periodic reads conducted by one or more of the tags 102. In these embodiments, the time period may be accurate down to one read period that, for example might be “x” seconds. In some alternative embodiments, the data packets may be generated continuously while the tags 102 are within the predefined proximity 104.

In this and other embodiments, the tags 102 may be associated with an employee, which may be referred to as an employee tag; a resident, which may be referred to as a resident tag; or a location, which may be referred to as a location tag. In some alternative embodiments, the tags 102 may be associated with assets. The term “assets” as used herein refers to any equipment of a facility. Some examples of assets may include walkers, wheelchairs, pharmaceutical repositories, medical equipment, medical devices, etc. The tags 102 associated with the equipment may be further associated with an individual or may be tracked as asset tags as described herein. Additionally, in some embodiments, the tags 102 may be temporarily associated with individuals with temporary access to a facility. The individuals with temporary access may be tracked while they are within the facility. In addition, a proximity between the individual with temporary access and an employee, a location, an asset, or a resident may be tracked.

In some embodiments, the association between the tags 102 and the employee, the resident, the location, the asset, and the individual with temporary access may be unique. In these and other embodiments, a single tag 102 is associated with a single employee, resident, asset, and individual with temporary access. Thus, a signal communicated from the tag 102 may include identifying information that corresponds to a specific employee, a specific resident, a specific location, etc. uniquely associated with tag 102.

Employee tags may be worn on a wristband or on a lanyard, for instance. The resident tag may be worn on a wristband, on a lanyard, or attached to a mobility device of the resident such as a wheelchair or a walker, for instance (i.e., as described herein with reference to an asset tag). One resident may have multiple resident tags associated with him. Location tags may be powered by an internal power source, such as a battery and/or an external power source, such as a wall outlet. More than one location tag may be associated with one location. Some examples of specific locations may include a room assigned to a resident, the bathroom associated with a room assigned to a resident, a common area such as the dining room or segment of hallway, a room in which a particular piece of equipment is located, a perimeter of a facility, a staff-only area, etc.

In this and other embodiments, the tags 102 may include RFID tags. Generally, an RFID tag may include a RFID chip and an antenna. An identifier may be included in the RFID chip. The identifier may be included in a radio frequency (RF) signal, which may be communicated via the antenna to a system configured to receive the RF signal. One or more of the tags 102 may include an active RFID tag, a passive RFID tag, an RFID reader, other types of wireless and/or remote technologies such as infrared (IR) or spread spectrum, or some combination thereof. The RFID reader may be configured to communicate a supply signal that may power a passive RFID tag. In response, the passive RFID tag may communicate an RF single include an identifier, which may be received by the RFID reader. The active RFID tag may communicate an RF signal including the identifier to a system configured to receive the RF signal.

Additionally, one or more of the tags 102 may be configured to determine a proximity between the tags 102. In some embodiments, the proximity may be determined by limiting an effective range within which the tags 102 are able to trigger one or more of the other tags 102. For example, outside of the predetermined proximity 104, the tags 102 may not communicate. Thus, in these embodiments, the proximity may be calculated as greater than or less than the predetermined proximity 104. In some alternative embodiments, a proximity may be calculated using received signal strength indication (RSSI). In these and other embodiments, one or more of the tags 102 may be configured to use RSSI to calculate the proximity. The proximity may be included in the data packets communicated to the base station 106.

Additionally, the tags 102 may include one or more sensors, firmware, a processor, etc. For example, some facilities implementing the system 100 may be required to record temperatures of refrigeration units in kitchen areas and/or resident rooms. The facilities may integrate a temperature sensor into the tags 102 to measure temperatures as well as document that an employee was actually present in a location in which a temperature was measured. The temperature as well as locational information may be included in data packets created by the tags 102

The data packets are communicated from the tags 102 to the base station 106. The base station 106 may include any device or combination of devices capable of one or more of the functionalities described herein. Specifically, the base station 106 may be configured to receive the data packets from one or more of the tags 102. For example, in this and other embodiments, the second tag 102B may be configured to communicate the data packets to the base station 106. In other embodiments, the base station 106 may additionally or alternatively receive data packets from the location tags, the employee tags, and/or the resident tags. Additionally, the base station 106 may be configured to ensure that the data packets are properly formatted and/or ensure the data packets include the correct elements of the locational information. The base station 106 may be configured to communicate the data packets to a central station 108.

In the depicted embodiment, three tags 102 and one base station 106 are included. This depiction is not meant to be limiting. The embodiment depicted in FIG. 1 may represent a simplification of the system 100. Embodiments of the system 100 may include more than three tags 102 and/or more than one base stations 106 that communicate data packets throughout the system 100.

The central station 108 may be configured to receive the data packets from the base station 106. The central station 108 may include a recording module 110, which may be configured to calculate an event timeframe from the data packets. The event timeframe may include a start date/time of an event, an end date/time of the event, a location of the event, an identification of an employee involved in the event, an identification of a resident involved in the event, an identification of an asset involved in the event, or some combination thereof.

The term “event” as used herein relates to an instance in which care may have been provided by an employee to a resident. For example, an event may be determined by the recording module 110 from data packets indicating an employee was present in a location associated with a resident. Additionally or alternatively, an event may be determined by the recording module 110 from data packets indicating an employee and a resident were together in a specific location. Additionally or alternatively, an event may be determined by the recording module 110 from data packets related to an event-triggering employee, an event-triggering resident, or an event-triggering location (described herein).

The resident involved in an event may be determined by the recording module 110 in multiple ways. In some embodiments, the recording module 110 may determine the resident involved in the event from data packets indicating that the employee is in a location that is associated with the resident. For example, the data packets may indicate that an employee is in a room associated with the resident. Additionally or alternatively, the recording module 110 may determine the resident involved in an event from data packets indicating that the employee is with the resident in a specific location during a time period. For example, the data packets may indicate that the resident and the employee were both in an examination room for a period of time consistent with a physical examination. In this example, a first set of data packets may include locational information pertaining to the employee and a second set of data packets may include locational information pertaining to the resident. The first set and the second set of data packets may be measured from a tag 102 positioned at the specific location.

Once the event timeframes are calculated, the event timeframes may be resolved. Resolving the event timeframes may include, but is not limited to, resolving conflicting data packets; combining a first event timeframe with a second event timeframe when the first event timeframe and the second event timeframe occur within a predetermined amount of time; and deleting or flagging data packets that indicate two or more locations for an employee or a resident during a time period.

In some embodiments, when computing and/or resolving the event timeframes, the recording module 110 may use configuration information. The configurable information may account from pragmatic or routine circumstances and thereby enable accurate event timeframe calculation/resolution. Some example configuration information may reflect care that is provided routinely in sequential locations, care that is provided for multiple residences simultaneously, a configuration time allotment for care that may be temporarily interrupted, facility layouts or facility-resident allocations (e.g., whether rooms are shared by residents having similar needs), etc. The configurable information may be updated and/or modified to reflect care provided by a facility implementing the system 100.

For example, the recording module 110 may calculate two event timeframes involving the same employee, the same resident, and the same location. The first event timeframe may end one minute prior to a beginning of the second event timeframe. This may be indicative of an employee leaving the location for a short amount of time to retrieve a needed item and returning one minute later to finish providing the care. A configuration time allotment may be included in the configurable information to enable the recording module 110 to combine the first event timeframe with the second timeframe, which may more accurately represent the care provided in this circumstance.

The event timeframes may then be communicated to a user interface 116 that may be used for documentation of the event timeframes by one or more employees. The user interface 116 may be a central computing system, a mobile device, etc. The user interface 116 may include an employee entry module 118. The employee entry module 118 may present event timeframes to the employees involved therein for further documentation. The employees may input designations that provide additional details of the event timeframes. The designations may include, but are not limited to, a specification of one or more types of care provided during the event timeframe; a specification of one or more residents to which care was provided during the event timeframe; a specification that no care was provided during the event timeframe; saving designations; and a modification to the event timeframe, such as combining one or more event timeframes or altering a resident, an employee, or a location included in the event timeframe. In some embodiments, multiple event timeframes may be presented to the employees. The employees may select one or more of the event timeframes and enter designations related to the one or more selected event timeframes.

The system 100 may also include a database 114. The database 114 may be configured to store data communicated in the system 100 or to external systems. In some embodiments, the database 114 may be configured to store all the event documentation, regardless if it is automatically gathered, calculated, or manually entered. For example, the database 114 may store the data packets, the event timeframes, and the designations.

Additionally, in some embodiments, recording module 110 may be configured to calculate and then store the event timeframes in the database 114. Accordingly, the employee entry module 118 may be configured to retrieve the event timeframes and other associated information stored in the database 114. For example, the event timeframes may be retrieved upon request by an employee. In response, the employee entry module 118 may display the event timeframes identifying the employee. The employee may then enter designations or other data into the database 114 using the employee entry module 118.

In addition to enabling accurate documentation of events in which care may have been provided by employees, the system 100 may enable further processing and communication of the data (e.g., event timeframes, designations, data packets, etc.) stored in the database 114. For example, in this and other embodiments, the system 100 may include a management module 112, which may be included in the central station 108. The management module 112 may access the data stored in the database 114, process the data, and export or present the data or information derived therefrom. The data or information derived therefrom may be presented to employees, residents, administrators, any other authorized individuals, an external system, or any combination thereof. Access to this data or information derived therefrom is not geographically limited to within the facility but may be achieved from any location worldwide with appropriate security validation and/or user authentication. Additionally, in some embodiments, the management module 112 may tabulate or format the data or information derived therefrom according to healthcare payer requirements and/or site auditor requirements.

For example, the management module 112 may access the data from the database 114. From the data, the management module 112 may generate POC event documentation, ADL scoring on a per-resident basis, ADL event documentation, POC scoring information, ADL scoring information, care summarization information on a per-employee basis, and care summarization information on a per-resident basis. The event documentation and/or the scoring information may be formatted as dictated by the CMS guidelines and/or another healthcare payer's preferences.

The management module 112 may then export the POC event documentation, the ADL event documentation, the POC scoring information, the ADL scoring information, or some combination thereof to an external billing system 120. Additionally or alternatively, the management module 112 may present care summarization information for the employee and care summarization information for the resident.

The management module 112 may also create a care report for a resident's family friends, physician, therapist, etc. (collectively, interested party). The care report may enable the interested party to visualize all of the current and/or recent care associated with the resident. The care reports may be offered as an additional service by the facility and may be delivered via various mediums to the interested parties. The mediums may include mobile devices such as smart phones or tablet personal computers and/or computing systems, for instance.

In some embodiment, event timeframes may only be calculated when the data packets indicate certain items. As mentioned above, in some embodiments, one or more of the tags 102 may be designated as an event-triggering tag. The event-triggering tag may be configured such that when data packets are generated from the event-triggering tag, the system 100 considers or categorizes the event timeframe calculated from the data packets as a documentable event. Generally, a documentable event is an event in which care was provided and/or an event for which a facility implementing the system 100 may bill. In some embodiments, the recoding module 110 may only calculate event timeframes for documentable events and discard data packets not indicating a documentable event.

For example, an employee associated with the first tag 102A may be designated as an event-triggering employee. Thus, when a data packet is generated identifying the event-triggering employee is involved, the system 100 considers or categorizes an event timeframe calculated from the data packet as a documentable event. In some embodiments, when the employee has not been designated as an event-triggering employee, events timeframes calculated from data packets identifying the employee may not be considered a documentable event.

In addition to an employee being designated as an event-triggering employee, a resident may be designated as an event-triggering resident and/or a location may be designated as an event-triggering location. The employee tags, resident tags, and location tags that are not designated as event-triggering are referred to herein as standard tags. Some example event-triggering circumstances and documentable events generated therefrom are described with reference to FIG. 1. The examples provided below include location tags, employee tags, and resident tags. However, in some alternative embodiments, similar event-triggering circumstances may include asset tags and/or tags 102 provided to individuals with temporary access to a facility.

In a first example, the first tag 102A may be a standard employee tag, the second tag 102B may be an event-triggering location tag, and the third tag 102C may be omitted. In the following examples, the item numbers (102A, 102B, and 102C) from FIG. 1 are used when referring to the type of tag. The standard employee tag 102A communicates a signal with the event-triggering location tag 102B. The signal includes identifying information for the standard employee tag 102A. The event-triggering location tag 102B receives the signal and combines the signal with identifying information of the event-triggering location tag 102B to create a data packet. The data packet is then communicated from the event-triggering location tag 102B to the base station 106, then to the central station 108 as described herein. The recording module 110 recognizes the data packet including the identifying information of the event-triggering location tag 102B as a documentable event.

In a second example, the first tag 102A may be a standard employee tag, the third tag 102C may be a standard resident tag, and the second tag 102B may be a standard location tag. The standard employee tag 102A and the standard resident tag 102C may communicate signals with the standard location tag 102B. The standard location tag 102B receives the signals and combines the signals with identifying information of the standard location tag 102B to create two data packets. The data packets are then communicated from the standard location tag 102B to the base station 106, then to the central station 108 as described herein.

In this example, an employee-to-resident event may be inferred by the recording module 110 because an employee associated with the standard employee tag 102A is in the same proximity as a resident associated with the standard resident tag 102C. The employee-to-resident may also be a documentable event.

In a third example, the first tag 102A may be an event-triggering location, the second tag 102B may be a standard employee tag, and the third tag 102C may be omitted. The third example is similar to the first example except that the event-triggering location tag 102A communicates a signal to the standard employee tag 102A. The signal includes identifying information pertaining to a location associated with the event-triggering location tag 102A. The standard employee tag 102B receives the signal, combines identifying information pertaining to the location with identifying information pertaining to the employee associated with the standard employee tag 102B to create a data packet. The standard employee tag 102B then communicates data packet to the base station 106. From the base station 106, the data packet is communicated to a central station 110 where the data packet is recognized and considered a documentable event.

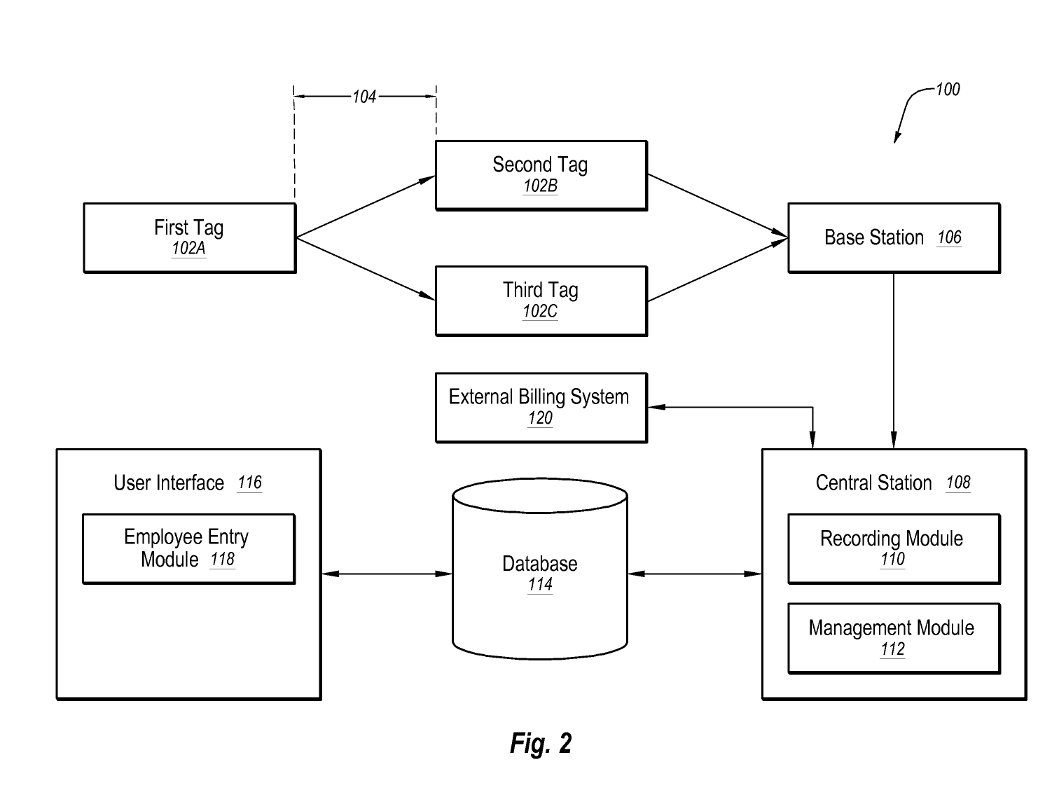

The above examples are not limiting to configurations of tags 102, designations of tags 102 as event-triggering, or events that may be calculated from data packets created in the tags 102. For example, FIG. 2 illustrates the system 100 with an alternative configuration of the tags 102. Specifically, in FIG. 2, the first tag 102A may be a standard location tag, the second tag 102B may include a standard employee tag, and the third tag 102C may include a standard resident tag. The standard location tag 102A communicates signals with both the standard employee tag 102B and the standard resident tag 102C. The signal communicated to each of the standard employee tag 102B and the standard resident tag 102C includes identifying information pertaining to a location associated with the standard location tag 102A.

The standard employee tag 102B receives a signal from the standard location tag 102A, combines the identifying information pertaining to the location with identifying information pertaining to the standard employee tag 102B to create a first data packet. The standard employee tag 102B communicates the first data packet to the base station 106. The first data packet is then communicated to the central station 108 Likewise, the standard resident tag 102C receives the same or a different signal from the standard location tag 102A, combines the identifying information pertaining to the location with identifying information pertaining to the standard resident tag 102C to create a second data packet. The standard resident tag 102C communicates the second data packet to the base station 106. The second data packet is then communicated to the central station 108.

Similar to the second example described with reference to FIG. 1, the two data packets may be calculated by the recording module 110 to indicate an employee-to-resident event.

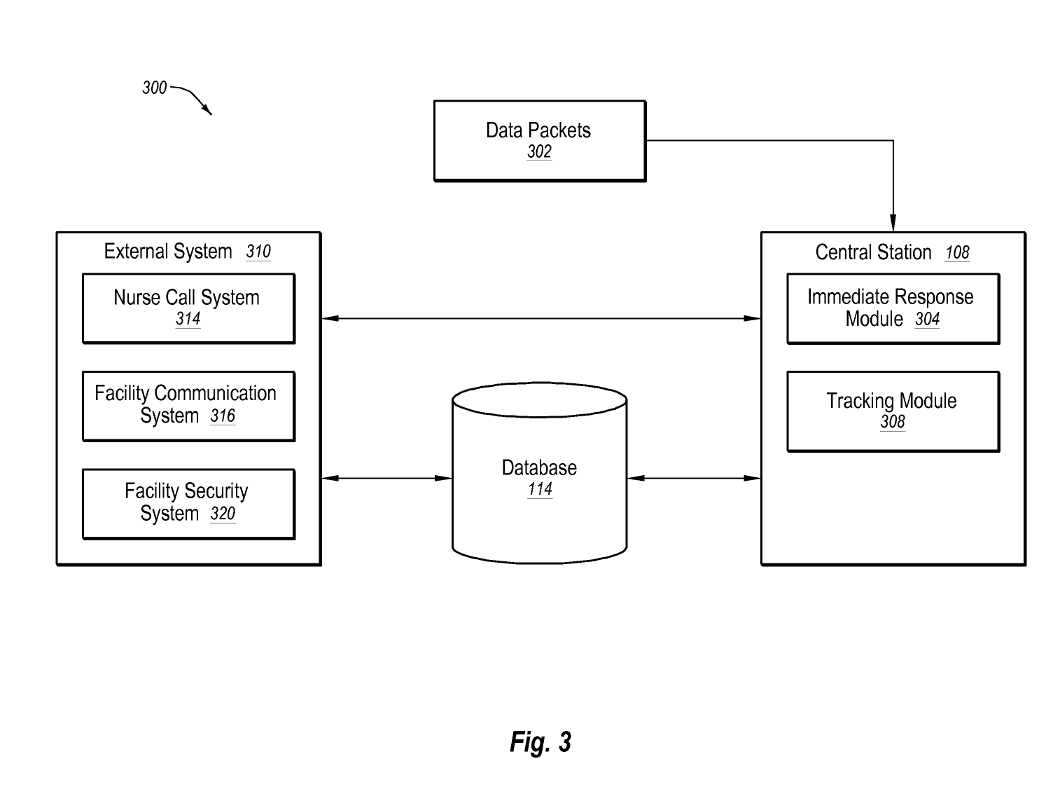

FIG. 3 illustrates an example system configuration 300 of the system 100 of FIG. 1 interfacing with one or more external systems 310. In the system configuration 300 multiple components and features (e.g., 114 and 108) of the system 100 are included. Some details of the components and features are not repeated with reference to FIG. 3. Additionally, in the system configuration 300 multiple components (e.g., 102, 106, 110, 112, 116, and 118) of the system 100 are omitted. Although not depicted, the system configuration 300 may include one or more of these components. In particular, in the system configuration 300, rather than including the tags 102 and base station 106, the system configuration 300 includes data packets 302. The data packets 302 are meant to indicate any of the data packets communicated throughout the system 100 as described herein in FIG. 1 and/or data packets as further described herein.

The central station 108 in the system configuration 300 may be configured to parse the data packets 302 for critical events. Generally, the critical events may include any circumstance in which real-time knowledge of the circumstance may benefit a facility, the residents, the employees, etc. When the critical events are detected, the central station 108 may be further configured to communicate an immediate response to one or more of the external systems 310. Each of the critical events may be subsequently or concurrently recorded as an event in which care may have been provided to a resident. Accordingly, an employee that provided the care during the critical event or in response to the critical event may document the care as described herein.

In the system configuration 300, the central station 108 may include an immediate response module 304. The immediate response module 304 may be configured to parse the data packets 302 for a critical event and to communicate an immediate response to one or more of the external systems 310. In some embodiments, the immediate response module 304 may be included in the recording module 110 of FIG. 1.

In this and other embodiments, some examples of critical events might include a call for help, a fall, a resident in an unauthorized location, or a resident performing an action requiring assistance. Additionally, the external systems 310 may include a facility communication system 316 or a facility security system 320. Some examples of critical events and immediate responses are described herein.

In a first example, a critical event may include a fall of a resident. To detect a fall, a resident tag and/or a location tag (e.g., tag 102 of FIG. 1) may include a computing system, firmware, and/or sensor such as an accelerometer configured to identify when a fall is anticipated due to changes in gait or movement, a fall has occurred, and/or when a fall has reached a critical nature. For example, the resident tag and/or a location tag may identify that a fall has reached a critical nature when there is no movement after an initially identified fall. The resident tag and/or a location tag may communicate data packets 302 indicating that a fall has occurred, an identity of the resident involved in the fall, the criticality of the fall, the location of the resident, or some combination thereof.

While parsing the data packets 302, the immediate response application 304 may detect the data packets 302 indicating a fall. When the fall is detected, in addition to storing the data packets 302 in the database 114, the immediate response module 304 may generate a notification indicating a fall has occurred, whether or not the fall is critical, and the location of the resident involved in the fall. The notification may be communicated to the facility communication system 316 where the notification may be passed along to an employee who is in a position to assist the resident involved in the fall and/or to management to provide timely notice of the event.

In some embodiments, the notification may be communicated by the immediate response module 304 before the data packets 302 are stored the database 114 or while the data packets 302 are being stored in the database 114. By generating and communicating the notification prior to the data packets 302 being stored in the database 114, the notification may be communicated as quickly as possible.

In a second example, the critical event may include a call for help by a resident, an employee, or another individual with temporary access to the facility. In some existing systems, a pendant or bracelet may be worn by employees and/or residents that, when activated, transmit a wireless signal that is sent to the nurse call system 314. The nurse call system 314 activates a light in a room associated with a resident activating the pendant. However, when the resident is outside the room, a responding employee may waste time first looking for the resident in the room before expanding the search for the resident elsewhere in the facility.

In the system configuration 300, one or more tags (e.g., 102 of FIG. 1) may be integrated with the pendant that transmits the wireless signal. Rather than the wireless signal being transmitted to nurse call system 314, a data packet 302 may be generated including a call for help as well as locational information and identifying information of the resident or the employee.

While parsing the data packets 302, the immediate response module 304 may detect a call for help. In response, the immediate response application may generate a notification. The notification may be communicated to the nurse call system 314 and/or the facility communication system 316. The notification may activate the light in a resident's room as well as communicate the location of the resident or employee who is calling for help.

The system configuration 300 and the employee entry module 118 of FIG. 1 may be further integrated with the nurse call system 314. When the nurse call is initiated by a resident, the occurrence can be associated with the employee who responded to the call. The nurse call and data generated by the nurse call system may thus be integrated with event timeframes. A special indicator may be displayed with the event timeframe when presented to the employee to emphasize importance of proper documentation of the event timeframe. By integrating the nurse call data with the event timeframe data, the employee who responded to a call may be required to provide designations including details of the critical event sufficient for documentation. Any non-documented call for help critical events may be tied to the employee that acknowledged the nurse call. Additionally, the timeliness and completeness of the documentation may be used as an indicator of employee performance.

In a third example, the critical event may include a resident in an unauthorized location or in a location indicating that the resident is performing an activity that requires assistance (collectively, resident in a questionable location). The critical event including the resident is in a questionable location may be customized on a per-resident basis and may be limited to certain times of day. For example, it may be acceptable for a resident to be in a library or in a courtyard during the day. However, if the resident is detected in either of these locations during the night, one or more tags (e.g., tags 102 of FIG. 1) may generate data packets 302 indicating that the resident is in an unauthorized location.

While parsing the data packets 302, the immediate response module 304 may detect the resident in the questionable location. When the resident in the questionable location is detected, the immediate response module 304 may generate a notification, which may be communicated to the facility communication system 316 and forwarded to an employee charged with recovering or assisting the resident. The notification may be sent prior to storing the data packets 302 in the database to recover or assist the resident as quickly as possible. Additionally or alternatively, the immediate response module 304 may communicate a signal to a facility security system 320. The signal may physically lock a door within a predefined distance (e.g., five feet) of a resident or may activate an assisting technology. The signal sent to the facility security system 320 may be referred to as a lock event. The system configuration 300 may store data packets 302 indicating the details of each of the lock events.

Additionally, the central station 108 may track movements of individuals and/or assets in a facility. In this and other embodiments, the central station 108 may include a tracking module 308 configured to track a progression of locations of an employee, a resident, individuals with temporary access to the facility such as vendors, maintenance personnel, visiting family/friends, or an asset over a predetermined time period and/or in real-time. The assets may include wheelchairs, walkers, vital sign devices, pharmaceutical repositories, etc. The progression of locations of the employee, the resident, other individuals, or the asset may be presented or otherwise used to derive information therefrom. For example, the progression of locations of an employee may be used to evaluate performance of the employee or document a location at a specific time of the employee. Likewise, the progression of locations of a resident may be used to evaluate mobility of a resident. Tracking of other individuals such as vendors, maintenance personnel, and visiting family/friends provides a level of security for both facility residents and assets. Additionally, the tracking module 308 may provide a current or most recent location of the individuals and/or the assets. This may be helpful in finding an asset or an individual or to reconcile the existence of rented equipment, for instance.

To generate the progression of locations, the tracking module 308 may use data packets 302 as they are received by the central station 108 and/or may access data packets 302 stored on the database 114. The progression of locations may be exported to any processing software or processed locally and may be presented in a textual format, a table, a grid, a facility map, etc.

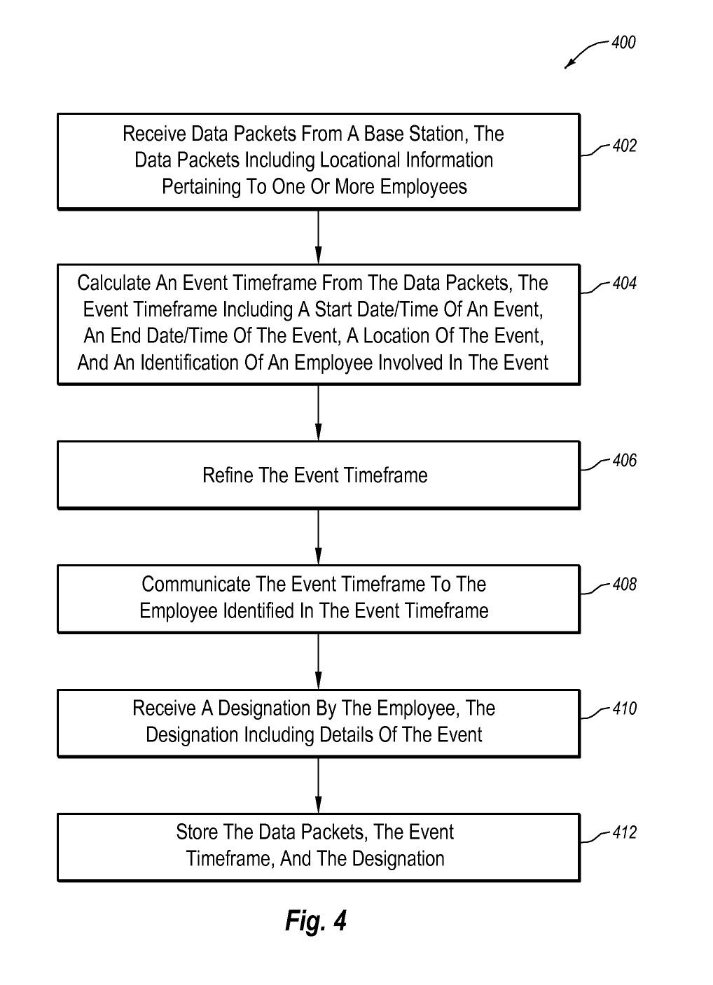

FIG. 4 illustrates a flow diagram of an example method 400 for employee activity and performance tracking that may be implemented in the system 100 of FIG. 1 and may be performed by the central station 108 and/or the user interface 116 of FIG. 1 in some embodiments. One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

The method 400 may begin at 402 in which data packets are received from a base station. The data packets may include locational information pertaining to one or more employees. Additionally, the data packets may include location information pertaining to one or more residents. The data packets may identify a tag associated with the employees and/or the residents and indicate a time period during which the employees and/or residents were at a specific location. An inference that care was provided by the employee to the residence based on the location information. In some embodiments, the data packets may only identify one or more employees and the specific location may be associated with a specific residence. Thus, the inference may be that because the employee was in the location associated with the resident, the employee was providing care to the resident. Additionally or alternatively, the data packets may identify the employees, the residence, and location information pertaining to both. The inference may be that care was provided by the employee to the resident due to the employee and the resident being in the specific location during the same time period.

At 404, one or more event timeframes may be calculated from the data packets. The event timeframes may include a start date/time of an event, an end date/time of the event, a location of the event, and an identification of an employee involved in the event. As mentioned above, the event timeframe may also include an identification of a resident involved in the event. The resident included in the event timeframe may be determined by data packets indicating that the employee is in a location that is associated with the resident or by data packets indicating that the employee was with the resident in the location during a time period.

At 406, the one or more event timeframes may be refined. Refining the event timeframe may include resolving conflicting data packets, combining the event timeframe with another event timeframe when the event timeframe and the other event timeframe occur within a predetermined amount of time, deleting or flagging data packets that indicate two or more locations of the employee and/or the resident during a time period, or some combination thereof.

At 408, the event timeframe may be communicated to the employee identified in the event timeframe. At 410, a designation may be received by the employee. The designation may include on or more details of the event. Some example designations may include a specification of one or more types of care provided during the event timeframe, a specification of one or more residents to which care was provided during the event timeframe, a specification that no care was provided during the event timeframe; and/or a modification to the event timeframe. At 412, the data packets, the event timeframe, and the designation may be stored.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments. For instance, care summarization information for the employee, care summarization information for the resident, ADL scoring on a per-resident basis, or some combination thereof may be generated and presented.

Additionally or alternatively, the method 400 may include generating POC event documentation, ADL event documentation, POC scoring information, ADL scoring information, or any combination thereof. The POC event documentation, the ADL event documentation, the POC scoring information, the ADL scoring information or any combination thereof may be exported to an external billing system in a format as dictated by a healthcare payer.

Additionally or alternatively, a progression of locations of an individual such as the employee, the resident, or an individual with temporary access to a facility may be tracked over a predetermined time period. The progression of locations of the employee, the resident, or the individual with temporary access may be presented.

Additionally or alternatively, the data packets may be parsed for a critical event. When the critical event is detected, an immediate response may be communicated to an external system. The critical event may include a call for help, a fall of a resident, a resident in an unauthorized location, an employee in an unauthorized location, a resident performing an action requiring assistance, or some combination thereof. The immediate response includes a notification, a signal to confine the resident. The external system may include a facility communication system, or a facility security system.

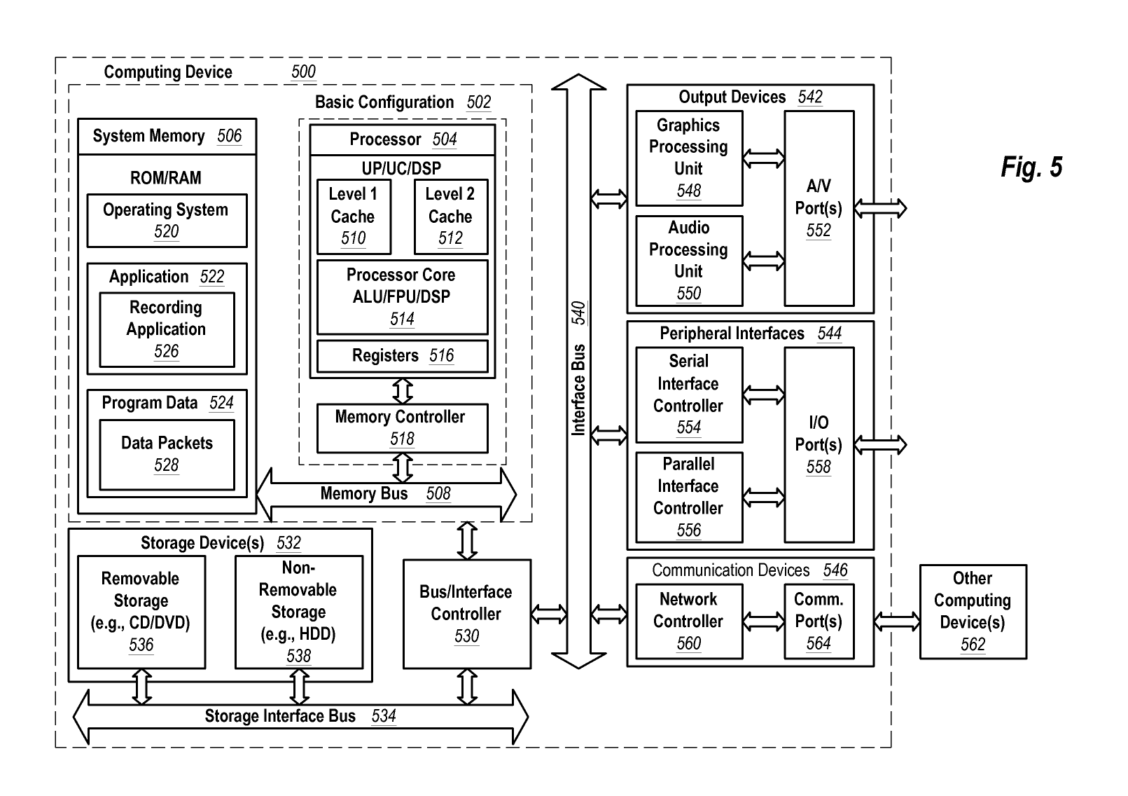

FIG. 5 is a block diagram illustrating an example computing device 500 that is arranged for employee activity and performance tracking in accordance with at least one embodiment of the present disclosure. The example computing device 500 may include any combination of the central station 108, the base station 106, the user interface 116, and one or more tags 102 of FIG. 1 in some embodiments. In a basic configuration 502, computing device 500 typically includes one or more processors 504 and a system memory 506. A memory bus 508 may be used for communicating between processor 504 and system memory 506.

Depending on the desired configuration, processor 504 may be of any type including but not limited to a microprocessor (μP), a microcontroller (μC), a digital signal processor (DSP), other logical processing devices, or any combination thereof. Processor 504 may include one more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with processor 504, or in some implementations memory controller 518 may be an internal part of processor 504.

Depending on the desired configuration, system memory 506 may be of any type including but not limited to volatile memory, non-volatile memory, other operational memory, or any combination thereof. System memory 506 may include an operating system 520, one or more applications 522, and program data 524. Application 522 may include a recording application 526 that is arranged to calculate event timeframes. Program data 524 may include data packets 528 that may be useful for employee activity and performance tracking as described herein. In some embodiments, application 522 may be arranged to operate with program data 524 on operating system 520 such that the calculation of event timeframes may be performed on the computing device 500. This described basic configuration 502 is illustrated in FIG. 5 by those components within the boxed area.

Computing device 500 may have additional features or functionality, and additional interfaces to facilitate communications between basic configuration 502 and any required devices and interfaces. For example, a bus/interface controller 530 may be used to facilitate communications between basic configuration 502 and one or more data storage devices 532 via a storage interface bus 534. Data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 506, removable storage devices 536, and non-removable storage devices 538 are some examples of computer storage media. Computer storage media includes, but is not limited to, RAM, ROM, EEPROM, flash memory or other memory technologies, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

Computing device 500 may also include an interface bus 540 for facilitating communication from various interface devices (e.g., output devices 542, peripheral interfaces 544, and communication devices 546) to basic configuration 502 via bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), 802.11, personal area networks, and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 may also be implemented as a personal computer including both laptop computer and non-laptop computer configurations.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method of employee activity and performance tracking comprising:
receiving data packets from a base station, the data packets including locational information pertaining to one or more employees;
calculating an event timeframe from the data packets, the event timeframe, including a start date/time of an event, an end date/time of the event, a location of the event, and an identification of one or more employees involved in the event;
refining the event timeframe;
communicating the event timeframe to the one or more employees identified in the event timeframe;
receiving a designation by the one or more employees, the designation including details of the event; and
storing the data packets, the event timeframe, and the designation.

2. The method of claim 1, wherein the event timeframe further includes an identification of one or more residents involved in the event.

3. The method of claim 2, wherein the one or more residents is identified by data packets indicating that the one or more employees is in the location which is associated with the one or more residents or by data packets indicating that the one or more employees is with the one or more residents in the location during a time period.

4. The method of claim 2, further comprising:
generating care summarization information on a per-employee basis and care summarization information on a per-employee basis; and
presenting the care summarization information.

5. The method of claim 2, further comprising:
generating an activity of daily living (ADL) scoring on a per-resident basis; and
presenting the ADL scoring on a per-resident basis.

6. The method of claim 2, further comprising:
generating points of care (POC) event documentation, activities of daily living (ADL) event documentation, POC scoring information, and ADL scoring information; and
exporting the POC event documentation, the ADL event documentation, the POC scoring information, and the ADL scoring information to an external billing system in a format as dictated by a healthcare payer.

7. The method of claim 2, further comprising:
tracking a progression of locations of the one or more individuals with temporary access to a facility while the one or more individuals are within the facility; and
presenting the progression of locations of the individuals with temporary access to the facility.

8. The method of claim 1, wherein the designation includes:
a specification of one or more types of care provided during the event timeframe;
a specification of one or more residents to which care was provided during the event timeframe;
a specification that no care was provided during the event timeframe; and/or
a modification to the event timeframe.

9. The method of claim 1, wherein the refining includes:
resolving conflicting data packets;
combining the event timeframe with another event timeframe when the event timeframe and the other event timeframe occur within a predetermined amount of time; and
deleting or flagging data packets that indicate two or more locations of the employee during a time period.

10. The method of claim 1, further comprising:
parsing the data packets for a critical event; and
when the critical event is detected, communicating an immediate response to a designated external system.

11. The method of claim 10, wherein:
the critical event includes a call for help, the immediate response includes a notification, and the external system includes a facility communication system;
the critical event includes a fall, the immediate response includes a notification, and the external system includes a facility communication system;
the critical event includes a resident in an unauthorized location, the immediate response includes a notification, and the external system includes a facility communication system;
the critical event includes an employee in an unauthorized location, the immediate response includes a signal to confine the resident, and the external system includes a facility security system; or
the critical event includes a resident performing an action requiring assistance, the immediate response includes a notification, and the external system includes a facility communication system.

12. An activity tracking system comprising:
a first tag;
a second tag configured to generate data packets when the first tag is within a predefined proximity of the second tag;
a base station configured to receive the data packet from the second tag; and
a central station configured to receive the data packets from the base station, the central station including a processor and a non-transitory computer-readable medium communicatively coupled to the processor and having computer-executable instructions stored thereon that are executable by the processor to calculate an event timeframe from the data packets, the event timeframe including a start date/time of an event, an end date/time of the event, a location of the event, an identification of an employee involved in the event, and an identification of a resident involved in the event.

13. The activity tracking system of claim 12, further comprising a third tag, wherein:
the second tag is configured to generate the data packet when the first tag and the third tag are within the predefined proximity of the second tag; and
the first tag is uniquely associated with an employee, the second tag is uniquely associated with a location, and the third tag is uniquely associated with a resident.

14. The activity tracking system of claim 12, further comprising a third tag, wherein:
the third tag is configured to generate another data packet when the first tag is within the predefined proximity of the third tag; and
the first tag is uniquely associated with a location, the second tag is uniquely associated with an employee, and the third tag is uniquely associated with a resident.

15. The activity tracking system of claim 12, wherein one of the first tag or the second tag is designated as an event-triggering tag configured such that when the data packets are generated, the system considers the event timeframe calculated from the data packets a documentable event.

16. The activity tracking system of claim 12, wherein one or more of the first tag and the second tag include an active radio frequency identification (RFID) tag or a passive RFID tag.

17. The activity tracking system of claim 12, wherein one or more of the first tag and the second tag are configured to determine a proximity between the first tag and the second tag by limiting an effective range within which the first tag is able to trigger the second tag or one or more of the first tag and the second tag are configured to use received signal strength indication (RSSI) to calculate the proximity.

18. An activity tracking system comprising:
a central station including a processor and a non-transitory computer-readable medium communicatively coupled to the processor and having computer-executable instructions stored thereon that are executable by the processor to perform operations comprising:
receiving data packets including locational information related to employees and locational information related to residents;
parsing the data packets for a critical event;
when the critical event is detected, communicating an immediate response to an external system;
calculating event timeframes from the data packets, the event timeframe including a start date/time of an event, an end date/time of the event, a location of the event, an identification of the employee involved in the event, and an identification of the residents involved in the event;
communicating the event timeframes to the employees involved in the event; and
receiving designations from the employees, the designations adding details to the event.

19. The activity tracking system of claim 18, further comprising a first tag and a second tag, wherein the operations further comprise designating one or more of the first tag and the second tag as an event-triggering tag that generates data packets that the central station categorizes as a documentable event.

20. The activity tracking system of claim 18, further comprising a third tag, wherein one or more of the first tag, the second tag, and the third tag are configured to detect a fall and generate a data packet indicating the fall has occurred, the data packet being configured to be identified as a critical event by the central station.
